(19) United States
(12) Patent Application Publication
(10) Pub. No.: US 2014/0006253 A1
(43) Pub. Date: Jan. 2, 2014

(54) LOCATION-BASED CREDIT PROVISION SYSTEM

(71) Applicants: Frank Anthony Nuzzi, Pflugerville, TX (US); James Brett Sowder, Austin, TX (US)

(72) Inventors: Frank Anthony Nuzzi, Pflugerville, TX (US); James Brett Sowder, Austin, TX (US)

(73) Assignee: eBAY, Inc., San Jose, CA (US)

(21) Appl. No.: 13/538,081

(22) Filed: Jun. 29, 2012

(51) Int. Cl. G06Q 40/02

(52) U.S. Cl. 705/38

(57) ABSTRACT

A method for providing credit to a user includes receiving user data associated with the user and location data associated with a location from a user device of the user over a network. User spending data for the user at the location is then retrieved from a database using the user data and the location data, and the user spending data is used to determine a location-based credit score for the user at the location. In some embodiments, merchant data for the location may also be retrieved to determine whether the location is a trusted merchant location and/or to help determine the location-based credit score. A location-based credit line for the user at the location is created in a database, and a location-based credit offer is sent to the user device over the network that includes an indication of the location-based credit line for the user at the location.

### BACKGROUND

1. Field of the Invention

The present invention generally relates to online and/or mobile payments and more particularly to a location-based credit provision system.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Consumers sometimes use credit in order to make purchases. For example, a credit account provider will typically provide a credit account to the consumer that the consumer may use to make purchases. Those purchases are then paid for by the credit account provider, with the consumer paying the credit account provider at a later date. Credit for making purchases with the credit accounts is typically provided to the consumer based on a risk associated with extending that credit, which is determined using a consumer-based credit score that is calculated based on the consumers payment history, the consumers current amount owed, the length of consumers credit history, the consumers new credit application history, and the types of credit used by the consumer. Such conventional credit provision systems and methods are limited to extending credit based on the above detailed consumer-specific attributes, and thus often do not extend credit in situations where the risk associated with extending that credit may be relatively low.

Thus, there is a need for an improved credit provision system.

### SUMMARY

According to one embodiment, a method for providing location-based credit includes receiving user data and location data from a user device. The user data and the location data may be used to retrieve user spending data for a user in a particular location. The user spending data for the user at the particular location may then be used to determine a location-based credit score, and a location-based credit line for the user at the location may then be created and offered to the user based on the location-based credit score.

In an embodiment, the method may also use the location data received from the user device to retrieve merchant data for one or more merchants at a location associated with the location data. That merchant data may then be used to help determine the location-based credit score. In some embodiments, the merchant data may indicate that the one or more merchants are trusted merchants and, in response, purchases by the user from those merchants may be insured.

As a result, a user may be offered a credit line based on that users previous spending behavior in a particular location. For example, a user that has demonstrated good spending behavior (e.g., the user has made a plurality of previous purchases at a particular location, has consistently paid off those purchases on time, has kept a minimum balance in an account used to make purchases, etc.) in particular location may be extended credit for use in that location based on that behavior. Furthermore, behavior of the merchant or merchants at those locations may effect the credit provided to the user, and purchases from the merchant or merchants by the user may be insured based on that merchant behavior.

These and other features and advantages of the present disclosure will be more readily apparent from the detailed description of the embodiments set forth below taken in conjunction with the accompanying figures.

### BRIEF DESCRIPTION OF THE FIGURES

FIG. 1 is a flow chart illustrating an embodiment of a method for providing credit to a user based at least partly on a location of the user;

FIG. 2 is a front view illustrating an embodiment of a user device being used to display a location-based credit offer;

FIG. 3 is a front view illustrating an embodiment of a user device being used to display a insured purchases indicator;

FIG. 4 is a schematic view illustrating an embodiment of a networked system;

FIG. 5 is a perspective view illustrating an embodiment of a user device;

FIG. 6 is a schematic view illustrating an embodiment of a computer system; and

FIG. 7 is a schematic view illustrating an embodiment of a location-based credit provision system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for providing credit based at least partly on the location of a user. User data associated with a user and location data associated with a location are received from a user device. The user data and the location data are then used to retrieve user spending data for the user at the location. That user spending data may then be used to determine a location-based credit score for the user at the location, and a location-based credit line that is available to the user to make purchases at the location may be created and provided to the user. These systems and methods allow a user to be provided credit based on their behavior in specific locations, particularly when that behavior indicates or is associated with a relatively low risk in extending credit.

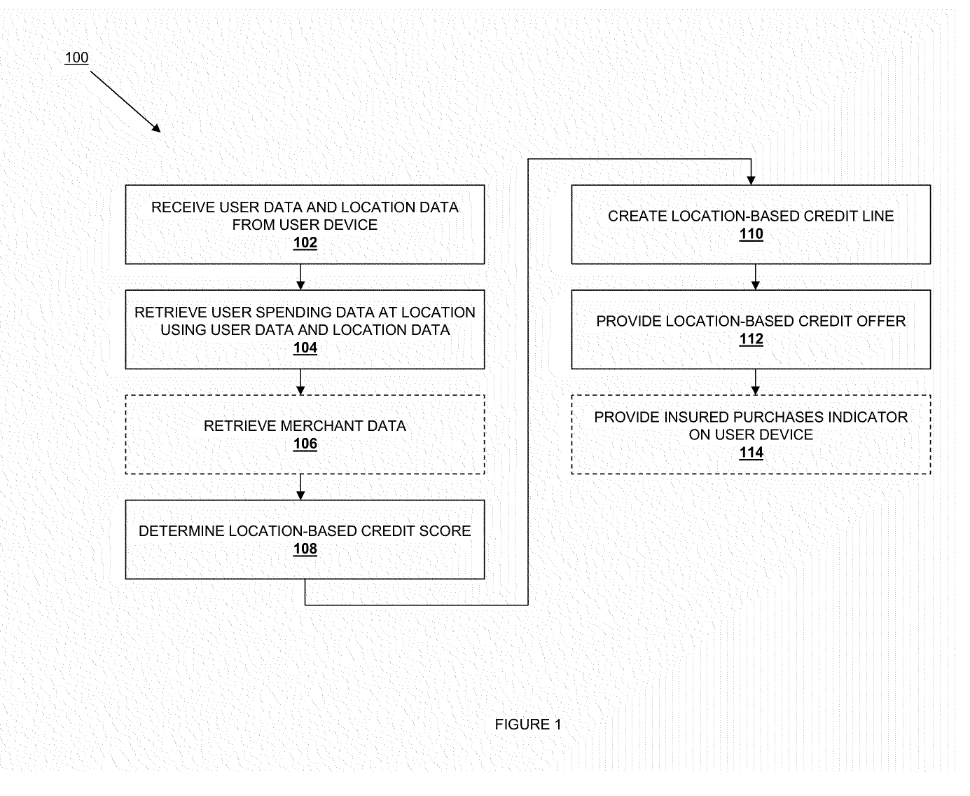

Referring now to FIG. 1, a method 100 for providing location-based credit is illustrated. In an embodiment of the method 100 described below, an account provider may provide a user with one or more payment accounts, and the user may use the payment accounts to fund payments for purchases made from merchants. For example, the user may be provided with a credit account, a debit account, a savings account, and/or a variety of other payments accounts known in the art. In another embodiment, a payment service provider such as, for example, PayPal, Inc. of San Jose, Calif., assists in the making of payments from the user to the merchant by transferring funds from the payment account of the user to a merchant account of the merchant. For any payment account provided to a user, payment account information may be stored in a user database, and that payment account information may include identifiers for the user, identifiers for a user device of the user, identifiers for the account, information about a plurality of previous purchases made by the user, information about the location of a plurality of previously purchases by the user, and/or a variety of other payment account information known in the art. However, these embodiments are meant to be merely exemplary, and one of skill in the art will recognize that a variety of modifications may be made to the location-based credit provision system discussed below without departing from the scope of the present disclosure.

The method 100 begins at block 102 where user data and location data are received from a user device. In the embodiments discussed below, the user includes a mobile user device such as for example, a mobile phone or other computing device, that includes user data such as, for example, a user identifier, a user payment account number, a user password, a user device identifier (e.g., a phone number), and/or a variety of other user data known in the art that may be associated with the identity of the user. The user device is operable to determine location data and, in some embodiments, send that location data along with the user data to the system provider device over a network. For example, the user device may include a location determination device (e.g., a Global Positioning System (GPS) device, a cell tower triangulation device, a WiFi location determination device, and/or a variety of other location determination devices known in the art) that is operable to determine a current location of the user device, and at block 102 the user device may send that current location over the network to the system provider device along with the user data. In some embodiments, the user device may automatically and periodically determine the location data and, in some embodiments, send the user data and the location data to the system provider device without an action required by the user. For example, block 102 may repeatedly be performed by the user device to automatically and periodically determine the location data as the user moves from location to location, with the method 100 only proceeding to blocks 104-114 when user spending data at a location associated with that location data is retrieved, discussed further below. In other embodiments, the user device may determine the location data in response to an action by the user (e.g., the launch of an application on the user device, the receipt of an instruction by the user, etc.) For example, block 102 may be performed only in response to the user instructing the user device to determine the location data (e.g., once the user has entered a location in which they have a spending history.) Thus, at block 102, user data and location data is received from the user device (e.g., by an application running on the user device, over the network by a system provider device, etc.)

The method 100 then proceeds to block 104 where user spending data at a location is retrieved using the user data and the location data. As discussed above, the location-based credit provision system includes one or more databases (hereafter referred to as user databases, although any of the databases discussed below may be combined while remaining within the scope of the present disclosure) that store payment account information for payment accounts of users. At block 104 of the method 100, the user data received at block 102 may be used to determine one or more payments accounts that belong to the user in the user database, and the location data received at block 102 may be used to retrieve user spending data of the user in a location that corresponds to the location data (i.e., the current location of the user.) For example, the system provider device may access the user database and use the user data to determine one or more payment accounts associated with the user data, then use the location data to determine a plurality of purchases made by the user using those payment account at that location (i.e., user spending data for the user at the location). In another example, the user device may use a location determination device to determine its current location, and then access one or more payment accounts of the user using the user data (e.g., a user name and password), and then use the current location to retrieve purchases made at the current location using those payment accounts (i.e., user spending data for the user at the location). Furthermore, in some embodiments, user spending data may include spending using cash such as, for example, when the user uses financial software in which the user records cash purchases at merchant locations.

In an embodiment, user spending data for the user at the location may include any purchases or payments made by the user that are within a predetermined distance of the current location of the user as determined using the location data. The user or the system provider may be able to select the predetermined distance, qualifying purchases (e.g., a maximum time period within which a previous purchase must have been made to be retrieved), and/or a variety of other user spending data variables for use in determining a location-based credit score, discussed in further detail below.

In some embodiments, block 102 of the method 100 may be skipped, and at block 104, the system provider may analyze a user's payment account information from one or more payment accounts to determine user spending data in particular locations similarly as described above. For example, a system provider device may be used to retrieve payment information from a plurality of payment accounts in user databases over a network and group that information (e.g., user spending data) that is determined to be in a common location.

In some embodiments, the method 100 may then proceed to optional block 106 where merchant data is retrieved. In some embodiments, merchant data may be stored in the one or more databases in the system (hereafter referred to as merchant databases, although the databases discussed below may be combined while remaining within the scope of the present disclosure.) For example, merchant data may include information about any purchases made from the merchant by any purchaser, along with information about any returns of those purchases. Thus, in some embodiments, merchant data may be retrieved by reviewing purchases from the merchant across a plurality of user payment accounts in the user databases. In another example, merchant data may include customer reviews of the merchant that are received by the system provider device and/or retrieved by the system provider device (e.g., over the network from a customer review website.) Thus, in some embodiments, merchant data may be retrieved by reviewing customer reviews in a merchant database. In another example, merchant data may include information about merchant payment actions by the merchant such as, for example, a merchant action performed in response to a customer returning an item. Thus, in some embodiments, merchant payment actions may be retrieved from a merchant database. The data discussed above and a variety of other merchant satisfaction data known in the art that indicates the satisfaction of customers with the merchant may be stored in a merchant database for retrieval at block 106 of the method 100. In some embodiments, the location data retrieved at block 102 is used to determine the location from which to retrieve merchant data from one or more merchants. In embodiments where block 102 is skipped, merchant data may be retrieved from merchants associated with user spending data determined from the analysis of the user's payment accounts.

The method 100 then proceeds to block 108 where a location-based credit score is determined. In an embodiment, the user device or the system provider device may use the user spending data retrieved at block 104 to determine a location-based credit score. As discussed above, the user spending data for the user at the location indicates the spending and payment behavior of the user at the location, and that spending and payment behavior may allow the determination of a location-based credit score. For example, a user may make regular purchases at a merchant location on a payment account such as a credit account, and then regularly pay off those purchases on time, which will have a positive effect on the location-based credit score (i.e., reflecting a lower risk in extending credit) for that merchant location, while few purchases and/or late payment for those purchases may have a negative effect on the location based credit score (i.e., reflecting a higher risk in extending credit). In another example, a user may make regular purchases from a variety of merchants at a location (e.g., a mall) on a payment account such as a credit account, and then regularly pay off those purchases on time, which will have a positive effect on the location-based credit score for that location, while few purchases and/or late payment for purchases may have a negative effect on the location-based credit score. In yet another example, a user may make regular purchases at a merchant location on a payment account such as a debit account (i.e., an account in which the user keeps a cash balance for the immediate payment of purchases using the account) while keeping a balance in the debit account that is above a minimum level, which may have a positive effect on the location-based credit score for that merchant location, while few purchases or not being able to maintain a minimum balance may have a negative effect on the location-based credit score.

While a few examples of location-based credit scores have been provided above, one of skill in the art will recognize that a variety of spending and payment behavior by a user at a location may be used to determined a location-based credit score while remaining within the scope of the present disclosure. Furthermore, the precise calculations for determining the location-based credit score may vary, as different weights may be assigned to different payment and spending behaviors in order to reflect more or less risk associated with extending credit to the user at the location received at block 102. Regardless of the details used to determine the location-based credit score, one of skill in the art will recognize that, at block 108, a score may be determined that reflects the risk associated with extending credit to the user based on a history of the user's spending and payment behavior at a given location.

Furthermore, in some embodiments, the merchant data retrieved at optional block 106 may also be used to determined the location-based credit score at block 108. For example, as discussed above, the merchant data may include merchant transaction data, merchant satisfaction data, merchant payment actions, customer reviews of the merchant, and/or a variety of other information that may effect the risk associated with extending credit to the user for use at the merchant location. For example, at the location associated with the location data received at block 102, returned purchases to the merchant or merchants, refusals by the merchant or merchants to accept returns, merchant disputes with credit account providers, negative customer reviews, and/or a variety of other data may indicate to the system provider device that additional costs may be associated with extending credit to the user for purchases at the location, and thus have a negative effect on the location-based credit score, while few returned purchases to the merchant or merchants, willingness by the merchant or merchants to accept returns, few merchant disputes with credit account providers, and positive customer reviews may have a positive effect on the location-based credit score.

The method 100 then proceeds to block 110 where a location-based credit line is created. In an embodiment, using the location-based credit score determined at block 108, a location-based credit line may be determined by using a risk indicated by the location-based credit score to determine whether to provide the user a credit line at the location received at block 102 and, if so, how much of a credit line to provide to the user at the location. For example, the system provider device may determine that the risk indicated by the location-based credit score is sufficiently low to provide the user a credit line at the location received at block 102, and then create a credit account that includes a credit line (e.g., an amount of credit available to the user for making purchases). In some embodiments, the amount of the credit line may be a function of the location-based credit score determined in block 108 of the method 100. However, in some embodiments, the amount of the credit line may be determined based on specific attributes of the spending behavior of the user at that location. For example, the system provider device may determine that the risk indicated by the location-based credit score is sufficiently low to provide the user a credit line at the location received at block 102, and then create a credit account that includes a credit line based on an average amount spent per month by the user at that location, a percentage of the average amount spent at that location, and/or a variety of other spending behaviors known in the art. The credit account created at block 110 may then be stored in a user database along with identifiers for the user, the user device, and the account, information about the location in which the credit account may be used (e.g., the location data retrieved in block 102 along with a set distance from that location data where the purchases may be made using the credit account, merchant locations associated with the user spending data retrieved in block 104, etc.), and/or a variety of other account information known in the art.

The location-based credit score and/or the location-based credit line may also be based on recent user purchase or credit history in general. For example, if the user has recently spent a lot of money on purchases or the user's credit has recently been lowered, this may adversely affect the amount of credit provided to the user at the current shopping location. On the other hand, if the user typically spends a lot of money during the current time period, such as between Thanksgiving and Christmas, post-Christmas, an anniversary, a birthday, etc., but the user has not spent much recently, this may positively affect the user's available credit line, even if the user has not historically spent much at the current shopping location.

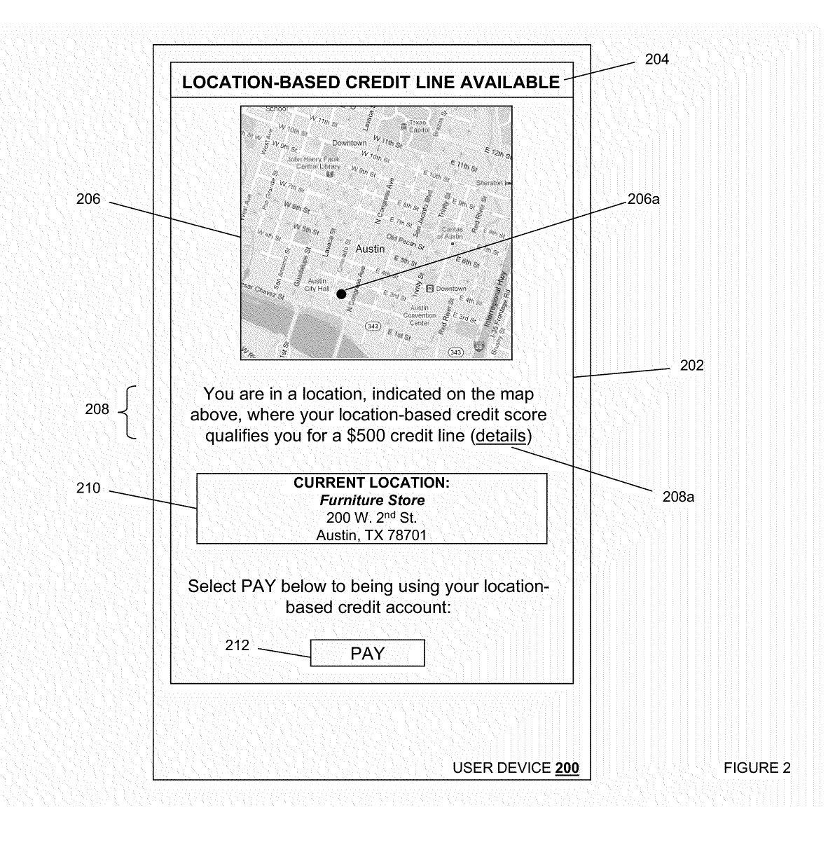

Referring now to FIGS. 1 and 2, the method 100 then proceeds to block 112 where a location-based credit offer is provided. FIG. 2 illustrates a user device 200 including a display screen 202 displaying a location-based credit offer 204. The location-based credit offer may be provided on the user device 200 as a webpage, an application screen, a “pop-up”, a text message, a picture message, and/or using a variety of other indicators known in the art. The location-based credit offer 204 includes a map 206 and a location indicator 206a that indicates the location associated with the location data received in block 102 of the method 100. The location-based credit offer 204 also includes credit offer information 208 that may indicate to the user at that they have qualified for a location-based credit line (e.g., $500 in the illustrated embodiment) along with a details link 208a that the user may select to retrieve details about the credit offer such as, for example, interest rate details for purchases made using the location-based credit line, the limits on the location where the location-based credit line may be used, and/or a variety of other credit line information known in the art. The location-based credit offer 204 also includes location details 210 that include information associated with the location data retrieved in block 102 such as, for example, a merchant name and merchant address for the merchant associated with the location data.

While single merchant is illustrated in the location-based credit offer 204 of FIG. 2, the location-based credit offer may be provided for a group of merchants in a location associated with the location data received in block 102. Thus, the location details 210 (and the location-based credit offer) may include a description of a location where the location-based credit line may be used with a plurality of merchants. The location-based credit offer 204 also includes a pay button 212 that the user may select in order to accept the location-based credit offer and immediately begin using the location-based credit line. Thus, upon receiving the location-based credit offer 204, the user may select the pay button 212 and use the user device 200 to make a purchase or purchases for up to the amount of the credit line at the location received at block 102.

In some embodiments, the method 100 may include optional block 114, where an insured purchases indicator is provided on the user device. While optional block 114 is illustrated as following block 112, it may be performed at different points during the method 100 and/or in place of blocks 110 and 112 without departing from the scope of the present disclosure. As discussed above, at optional block 106 merchant data may be retrieved. The merchant data may include merchant transaction data, merchant satisfaction data, merchant payment actions, customer reviews of the merchant, and/or a variety of other information that may effect the risk associated with insuring purchases from the merchant location. For example, at the location received at block 102, returned purchases to the merchant or merchants, refusals by the merchant or merchants to accept returns, merchant disputes with credit account providers, negative customer reviews, and/or a variety of other data may indicate to the system provider device that the risk of insuring purchases made at the user location is relatively high, while few returned purchases to the merchant or merchants, willingness by the merchant or merchants to accept returns, few merchant disputes with credit account providers, and positive customer reviews may indicate to the system provider device that the risk of insuring purchases made at the user location is relatively low. If the system provider device makes a determination that the risk of insuring purchases made at the merchant location is sufficiently low, an insured purchases indicator may be provided to the user device.

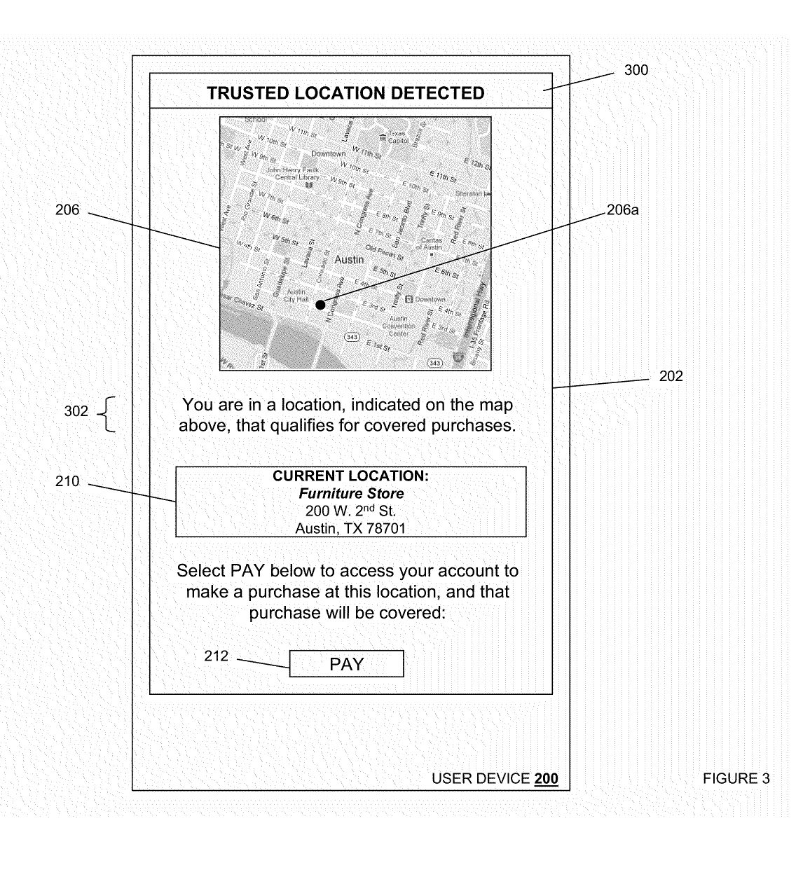

Referring now to FIG. 3, the use device 200 is illustrated as displaying an insured purchases indicator 300 on the display screen 202. The insured purchases indicator 300 is similar to the location-based credit offer 204, discussed above, and includes the map 206, the location indicator 206a, the location details 210, and the pay button 212. However, the insured purchases indicator 300 includes insured products information 302 replacing the credit offer information 208. The insured products information 302 indicates to the user that the merchant location or location with a plurality of merchants is a “trusted location” and qualifies for insured purchases. The user may then select the pay button to access a payment account of the user, and purchases made using that payment account may be insured (e.g., by the payment service provider, by the account provider, and/or by another system provider.) Insuring purchases may include covering the amount of the purchases for anything that may go wrong with the purchase such as, for example, when the purchase includes a defective product, when the purchase includes a unsatisfactory service, and/or a variety of other purchase defects known in the art.

In one example of the location-based credit provision system discussed above, a system provider may retrieve the spending and payment behavior of a user at a variety of locations using a variety of payment accounts. When the system provider determines that the spending and payment behavior of the user at a particular location indicates a relatively low risk in extending credit to the user for purchases at that location, the system provider may create and offer a credit line (or an additional credit line) to the user, or may solicit a credit account provider for a credit account that may be offered to the user. Thus, using the information retrieved during the method 100, the system provider may provide credit offers that conventional systems have not been able to provide, i.e., where the risk associated with offering credit is justified based on a particular users behavior in a particular location.

Furthermore, the systems and methods discussed above allow for a user to be provided a “tab”, or credit arrangement, at a merchant location where the merchant does not provide credit arrangements. For example, a user may frequent a particular merchant and exhibit positive user spending and payment behavior, discussed above, and that user may be offered a credit line at a relatively low interest rate that may only be used for purchases made at that merchant location. Furthermore, the system provider may reduce and/or eliminate fees for the merchant associated with the use of the credit line.

Thus, a system and method for providing credit based on a location of a user has been described that allows a system provider to provide credit to a user based on the users spending and payment behavior at particular locations when that behavior indicates that the risk associated with that extension of credit is acceptable. When a user device enters a location where the user has made previous purchases, user spending data can be retrieved upon receiving user data and location data from the user device. That user spending history allows a location-based credit score to be determined, and that location-based credit score may be used to create a location-based credit line that may be offered to the user. Such systems and methods allow a system provider to quickly determine whether a user is an acceptable credit risk with regard to purchases made at a particular location and, if so, make a credit offer to the user while they are at that location.

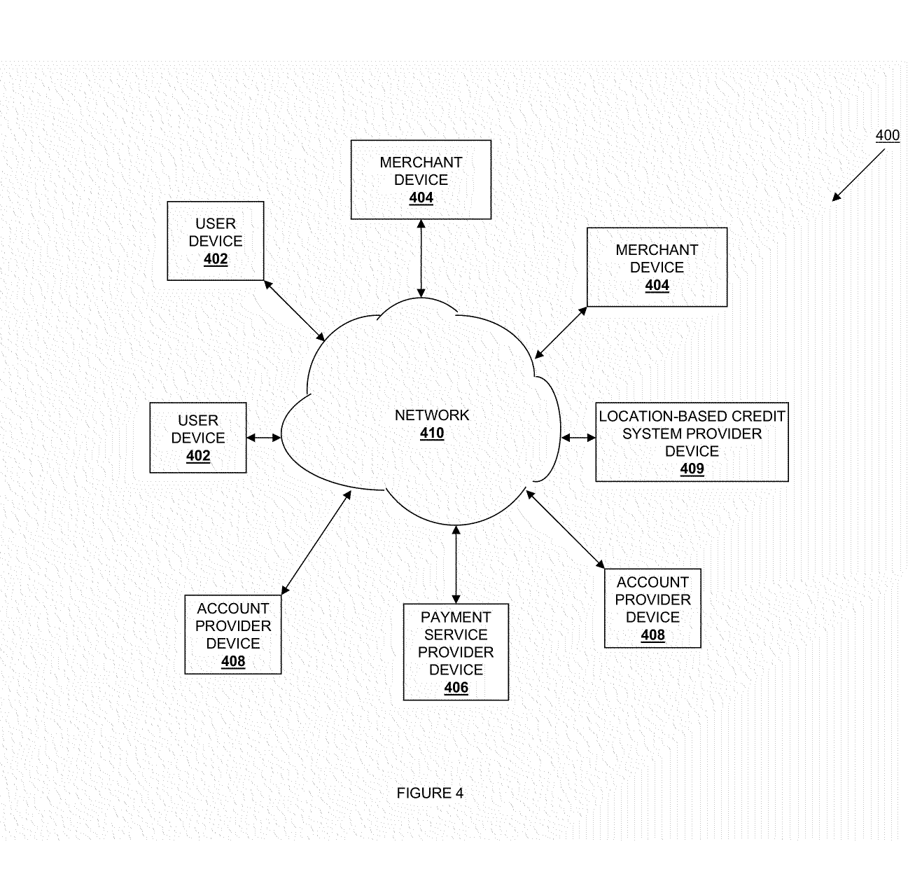

Referring now to FIG. 4, an embodiment of a networked system 400 used in the location-based credit provision system described above is illustrated. The networked system 400 includes a plurality of user devices 402, a plurality of merchant devices 404, a payment service provider device 406, a plurality of account holder devices 408, and/or a location-based credit system provider device 409 in communication over a network 410. Any of the user devices 402 may be the user device 200, discussed above. The merchant devices 404 may be the merchant devices discussed above and may be operated by the merchants discussed above. The payment service provider device 406 may be the payment service provider devices discussed above and may be operated by a payment service provider such as, for example, PayPal Inc. of San Jose, Calif. The account provider devices 408 may be the account provider devices discussed above and may be operated by the account providers discussed above such as, for example, credit card account providers, bank account providers, savings account providers, and a variety of other account providers known in the art.

The user devices 402, merchant devices 404, payment service provider device 406, account provider devices 408, and/or the location-based credit system provider device 409 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 400, and/or accessible over the network 410.

The network 410 may be implemented as a single network or a combination of multiple networks. For example, in various embodiments, the network 410 may include the Internet and/or one or more intranets, landline networks, wireless networks, and/or other appropriate types of networks.

The user device 402 may be implemented using any appropriate combination of hardware and/or software configured for wired and/or wireless communication over network 410. For example, in one embodiment, the user device 402 may be implemented as a personal computer of a user in communication with the Internet. In other embodiments, the user device 402 may be a smart phone, personal digital assistant (PDA), laptop computer, and/or other types of computing devices.

The user device 402 may include one or more browser applications which may be used, for example, to provide a convenient interface to permit the user to browse information available over the network 410. For example, in one embodiment, the browser application may be implemented as a web browser configured to view information available over the Internet.

The user device 402 may also include one or more toolbar applications which may be used, for example, to provide user-side processing for performing desired tasks in response to operations selected by the user. In one embodiment, the toolbar application may display a user interface in connection with the browser application.

The user device 402 may further include other applications as may be desired in particular embodiments to provide desired features to the user device 402. In particular, the other applications may include a payment application for payments assisted by a payment service provider through the payment service provider device 406. The other applications may also include security applications for implementing user-side security features, programmatic user applications for interfacing with appropriate application programming interfaces (APIs) over the network 410, or other types of applications. Email and/or text applications may also be included, which allow the user to send and receive emails and/or text messages through the network 410. The user device 402 includes one or more user and/or device identifiers which may be implemented, for example, as operating system registry entries, cookies associated with the browser application, identifiers associated with hardware of the user device 402, or other appropriate identifiers, such as a phone number. In one embodiment, the user identifier may be used by the payment service provider device 406 and/or account provider device 408 to associate the user with a particular account as further described herein.

The merchant device 404 may be maintained, for example, by a conventional or on-line merchant, conventional or digital goods seller, individual seller, and/or application developer offering various products and/or services in exchange for payment to be received conventionally or over the network 410. In this regard, the merchant device 404 may include a database identifying available products and/or services (e.g., collectively referred to as items) which may be made available for viewing and purchase by the user.

The merchant device 404 also includes a checkout application which may be configured to facilitate the purchase of items by the user. The checkout application may be configured to accept payment information from the user through the user device 402, the account provider through the account provider device 408, and/or from the payment service provider through the payment service provider device 406 over the network 410.

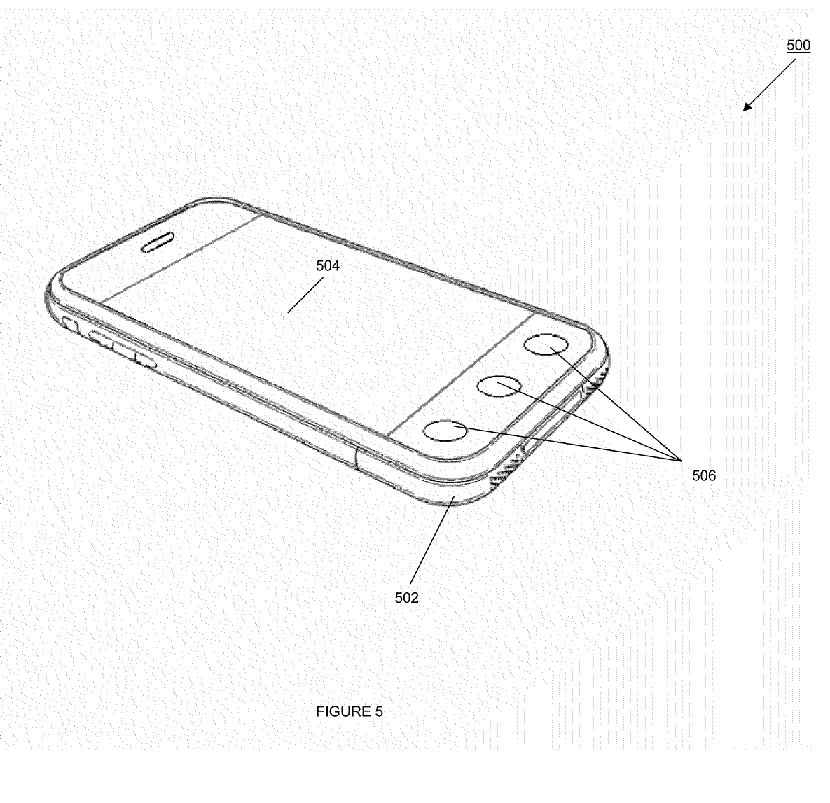

Referring now to FIG. 5, an embodiment of a user device 500 is illustrated. The user device 500 may be the user devices 200 and/or 402. The user device 500 includes a chassis 502 having a display 504 and an input device including the display 504 and a plurality of input buttons 506. One of skill in the art will recognize that the user device 500 is a portable or mobile phone including a touch screen input device and a plurality of input buttons that allow the functionality discussed above with reference to the method 100. However, a variety of other portable/mobile user devices and/or desktop user devices may be used in the method 100 without departing from the scope of the present disclosure.

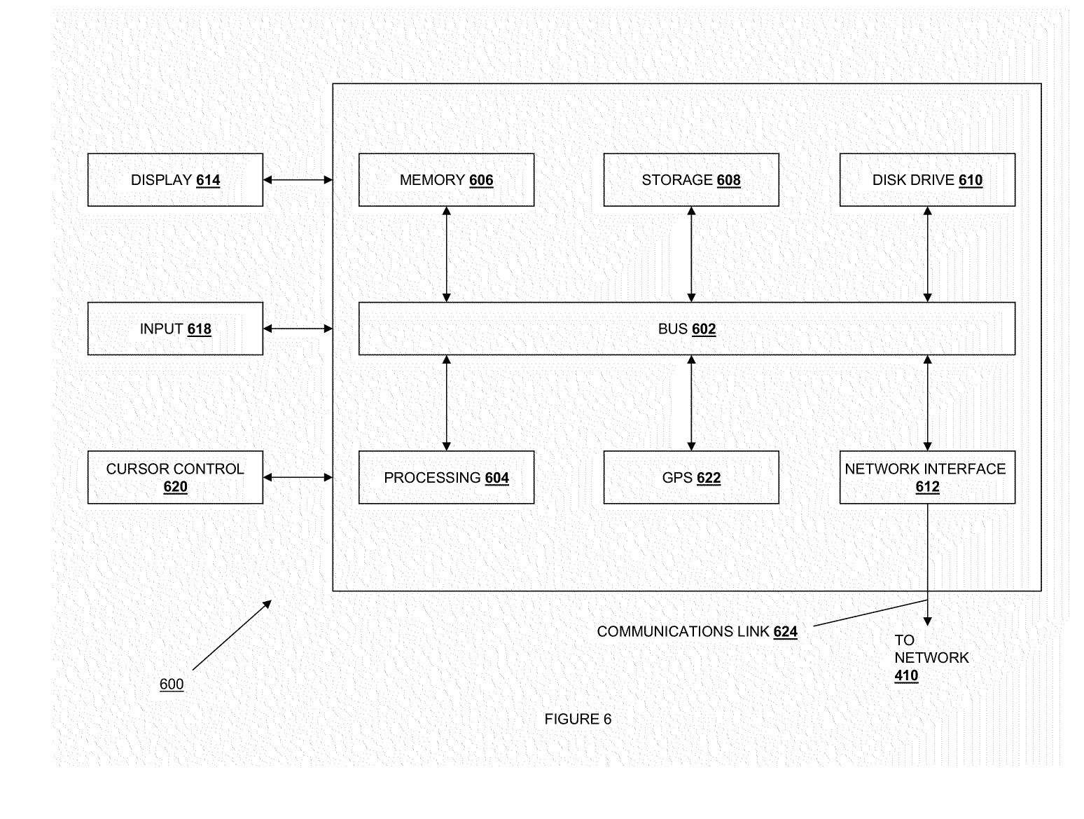

Referring now to FIG. 6, an embodiment of a computer system 600 suitable for implementing, for example, the user device 200, the user device 402, the user device 500, the merchant device 404, the payment service provider device 406, the account provider device 408, and/or the location-based credit system provider device 409 is illustrated. It should be appreciated that other devices utilized by users, merchants, payment service providers, and account providers in the location-based credit provision system discussed above may be implemented as the computer system 600 in a manner as follows.

In accordance with various embodiments of the present disclosure, computer system 600, such as a computer and/or a network server, includes a bus 602 or other communication mechanism for communicating information, which interconnects subsystems and components, such as a processing component 604 (e.g., processor, micro-controller, digital signal processor (DSP), etc.), a system memory component 606 (e.g., RAM), a static storage component 608 (e.g., ROM), a disk drive component 610 (e.g., magnetic or optical), a network interface component 612 (e.g., modem or Ethernet card), a display component 614 (e.g., CRT or LCD), an input component 618 (e.g., keyboard, keypad, or virtual keyboard), a cursor control component 620 (e.g., mouse, pointer, or trackball), and/or a location determination component 622 (e.g., a Global Positioning System (GPS) device as illustrated, a cell tower triangulation device, and/or a variety of other location determination devices known in the art.) In one implementation, the disk drive component 610 may comprise a database having one or more disk drive components.

In accordance with embodiments of the present disclosure, the computer system 600 performs specific operations by the processor 604 executing one or more sequences of instructions contained in the memory component 606, such as described herein with respect to the payer device 200, 402, and 500, the payee device(s) 404, the payment service provider device 406, the account provider device(s) 408, and/or the location-based credit system provider device 409. Such instructions may be read into the system memory component 606 from another computer readable medium, such as the static storage component 608 or the disk drive component 610. In other embodiments, hard-wired circuitry may be used in place of or in combination with software instructions to implement the present disclosure.

Logic may be encoded in a computer readable medium, which may refer to any medium that participates in providing instructions to the processor 604 for execution. Such a medium may take many forms, including but not limited to, non-volatile media, volatile media, and transmission media. In many embodiments, the computer readable medium is non-transitory. In various implementations, non-volatile media includes optical or magnetic disks, such as the disk drive component 610, volatile media includes dynamic memory, such as the system memory component 606, and transmission media includes coaxial cables, copper wire, and fiber optics, including wires that comprise the bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 600. In various other embodiments of the present disclosure, a plurality of the computer systems 600 coupled by a communication link 624 to the network 410 (e.g., such as a LAN, WLAN, PTSN, and/or various other wired or wireless networks, including telecommunications, mobile, and cellular phone networks) may perform instruction sequences to practice the present disclosure in coordination with one another.

The computer system 600 may transmit and receive messages, data, information and instructions, including one or more programs (i.e., application code) through the communication link 624 and the network interface component 612. The network interface component 612 may include an antenna, either separate or integrated, to enable transmission and reception via the communication link 624. Received program code may be executed by processor 604 as received and/or stored in disk drive component 610 or some other non-volatile storage component for execution.

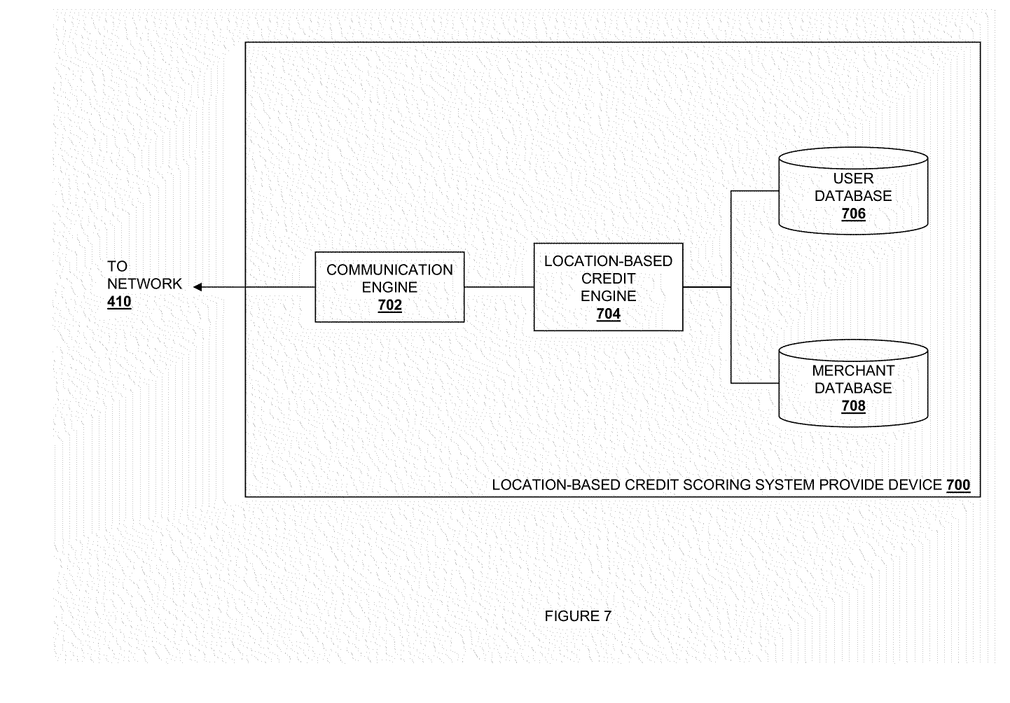

Referring now to FIG. 7, an embodiment of a location-based credit system provider device 700 is illustrated. In an embodiment, the device 700 may be the user device 200, 402, and 500, the payment service provider device 406 and/or the account holder device 408. The device 700 includes a communication engine 702 that is coupled to the network 410 and to an location-based credit engine 704 that is coupled to a user database 706 and a merchant database 708. The communication engine 702 may be software or instructions stored on a computer-readable medium that allows the device 700 to send and receive information over the network 410. The location-based credit engine 704 may be software or instructions stored on a computer-readable medium that allow the device 700 to receive user data, receive location data, retrieve user spending data from the user database 706, receive merchant data from the merchant database 708, determine a location-based credit score, create a location-based credit line, store a location-based credit line in the databases 206 and/or 208, send a location based-credit offer, send an insured purchases indicator, detect a purchase at a merchant location, and provide any of the other functionality that is discussed above. While the databases 706 and 708 have been illustrated as located in the payer device 700, one of skill in the art will recognize that they may be connected to the location-based credit engine 704 through the network 410 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

1. A location-based credit provision system, comprising:
a system provider device including one or more processors that are coupled to a memory and a network, wherein the one or more processors are operable to:
receive user data associated with a user and location data associated with a location from a user device over the network;
retrieve user spending data for the user at the location from one or more databases using the user data and the location data, wherein the user spending data for the user at the location includes a plurality of previous payments made by the user, and the plurality of previous payments included in the user spending data for the user at the location are restricted to previous payments made by the user at the location;
determine a location-based credit score for the user that is based on the user spending data for the user at the location and use the location-based credit score to create a location-based credit line for the user at the location in the one or more databases; and
send a location-based credit offer to the user device over the network that includes an indication of the location-based credit line for the user at the location.

2. The system of claim 1, wherein the plurality of previous payments included in the user spending data for the user at the location are restricted to previous payment made by the user within a predetermined distance of location data that identifies the location.

3. The system of claim 1, wherein the system provider device is further operable to:
retrieve merchant data for the location from the one or more databases using the location data, wherein the location-based credit score for a user at the location is determined using the merchant data.

4. The system of claim 1, wherein the system provider device is further operable to:
retrieve merchant data for the location from the one or more databases using the location data;
determine that the merchant data for the location corresponds to a trusted merchant location; and
send an insured-purchases indicator to the user device over the network that includes an indication that purchases from the trusted merchant location are insured.

5. The system of claim 4, wherein the merchant data includes a plurality of merchant payment actions by the merchant.

6. The system of claim 4, wherein the merchant data includes a plurality of customer reviews of the merchant.

7. The system of claim 4, wherein the system provider device is further operable to:
detect a purchase from the trusted merchant location by the user; and
insure the purchase.

8. A method for providing credit to a user, comprising:
receiving, by a system provider device, user data associated with a user and location data associated with a location from a user device over a network;
retrieving, by the system provider device, user spending data for the user at the location from one or more databases using the user data and the location data, wherein the user spending data for the user at the location includes a plurality of previous payments made by the user, and the plurality of previous payments included in the user spending data for the user at the location are restricted to previous payments made by the user at the location;
determining, by the system provider device, a location-based credit score for the user that is based on the user spending data for the use at the location and using the location-based credit score to create a location-based credit line for the user at the location in the one or more databases; and
sending, by the system provider device, a location-based credit offer to the user device over the network that includes an indication of the location-based credit line for the user at the location.

9. The method of claim 8, plurality of previous payments included in the user spending data for the user at the location are restricted to previous payment made by the user within a predetermined distance of location data that identifies the location.

10. The method of claim 8, further comprising:
retrieving, by the system provider device, merchant data for the location from the one or more databases using the location data, wherein the location-based credit score for a user at the location is determined using the merchant data.

11. The method of claim 8, further comprising:
retrieving, by the system provider device, merchant data for the location from the one or more databases using the location data;
determining, by the system provider device, that the merchant data for the location corresponds to a trusted merchant location; and
sending, by the system provider device, an insured-purchases indicator to the user device over the network that includes an indication that purchases from the trusted merchant location are insured.

12. The method of claim 11, wherein the merchant data includes a plurality of customer reviews of the merchant.

13. The method of claim 12, wherein the merchant data includes a plurality of merchant payment actions by the merchant.

14. The method of claim 8, further comprising:
detecting, by the system provider device, a purchase from the trusted merchant location by the user; and
insuring the purchase.

15. A non-transitory machine-readable medium comprising a plurality of machine-readable instructions which, when executed by one or more processors, are adapted to cause the one or more processors to perform a method comprising:
receiving user data associated with a user and location data associated with a location from a user device over a network;
retrieving user spending data for the user at the location from one or more databases using the user data and the location data, wherein the user spending data for the user at the location includes a plurality of previous payments made by the user, and the plurality of previous payments included in the user spending data for the user at the location are restricted to previous payments made by the user at the location;
determining a location-based credit score for the user that is based on the user spending data for the user at the location and using the location-based credit score to create a location-based credit line for the user at the location in the one or more databases; and
sending a location-based credit offer to the user device over the network that includes an indication of the location-based credit line for the user at the location.

16. The non-transitory machine-readable medium of claim 15, wherein the plurality of previous payments included in the user spending data for the user at the location are restricted to previous payment made by the user within a predetermined distance of location data that identifies the location.

17. The non-transitory machine-readable medium of claim 15, wherein the method further comprises:
retrieving merchant data for the location from the one or more databases using the location data, wherein the location-based credit score for a user at the location is determined using the merchant data.

18. The non-transitory machine-readable medium of claim 15, wherein the method further comprises:
retrieving merchant data for the location from the one or more databases using the location data;
determining that the merchant data for the location corresponds to a trusted merchant location; and
sending an insured-purchases indicator to the user device over the network that includes an indication that purchases from the trusted merchant location are insured.

19. The non-transitory machine-readable medium of claim 18, wherein the method further comprises:
detecting a purchase from the trusted merchant location by the user; and
insuring the purchase.

20. The non-transitory machine-readable medium of claim 18, wherein the wherein the merchant data includes a plurality of customer reviews of the merchant and a plurality of merchant payment actions by the merchant.
